(19) United States
(12) Patent Application Publication
(10) Pub. No.: US 2009/0044446 A1
(43) Pub. Date: Feb. 19, 2009

(54) Collapsible plant stand

(75) Inventors: Michael S. Kellogg, Oconomowoc, WI (US); Dean B. Krotts, Milwaukee, WI (US)

Correspondence Address: RYAN KROMHOLZ & MANION, S.C., POST OFFICE BOX 26618, MILWAUKEE, WI, 53226, US

(73) Assignee: Bajer Design & Marketing, Inc.

(21) Appl. No.: 11/891,917

(22) Filed: Aug. 14, 2007

(51) Int. Cl. A01G 17/14

(52) U.S. Cl. 47/45; 47/47

(57) ABSTRACT

An apparatus according to the present invention provides a collapsible plant stand. A plurality of flexible panels is joined to form a supportive structure. Each panel is formed from a flexible material coupled to a flexible frame member. At least one panel may include a plurality of apertures formed through the flexible material, through which a plant portion may be allowed to extend. Alternatively, or in addition to the panels having apertures, a stand according to the present invention may include a plurality of flexible frame members joined to form a support frame and a plurality of shelves coupled to the support frame, the shelves being adapted to support parts of a plant such as fruit. A plant stand may also include a weed barrier panel.

### BACKGROUND OF THE INVENTION

The present invention is related generally to plant husbandry, and more specifically to a collapsible plant support structure or stand.

Collapsible plant stands have been desirable, and indeed employed, for decades. Generally, prior plant stands involve two methods of collapsibility, both of which have their respective drawbacks.

First, many prior collapsible plant stands comprise only a plurality of rigid support members. While offering the benefits of suitable plant support and collapsibility, there are at least two potential disadvantages to such devices. One disadvantage of using collapsible plant stands incorporating several rigid members is that such stands may create a safety concern. Plant stands may be used in a garden. In a garden, it is common for gardeners to pull weeds while standing and bending their torsos to an inverted position. While not a desirable consequence, a gardener may lose balance and accidentally fall onto nearby plant stands. Plant stands incorporating rigid components may cause severe injury, depending on the contact. Similar unsafe contact may occur if supported plants are near areas in which children engage in play.

Another disadvantage of using plant stands incorporating rigid structural members is the required assembly and disassembly during setup and storage, respectively. For a given plant stand structure, as the desired storage size of a given plant stand decreases, the required number of pieces into which it must be broken down increases, as does the time required for assembly and disassembly.

Second, some prior collapsible plant stands utilize a combination of rigid support members and several interconnecting flexible members such as rope, cable or twine. Again, similar to plant stands employing only rigid support members, these prior devices offer suitable plant support and collapsibility; however, sacrifice is often made during storage. The flexible members of prior devices tend to become entangled during the non-growing season, often causing frustration during preparation for the next season's use. In addition, depending upon the design of the plant support, the same safety concerns mentioned above may be present with stands of this second type.

Therefore, the art of plant husbandry would benefit from an improved collapsible plant stand that addresses at least the stated safety, assembly, and storage concerns surrounding prior devices.

### SUMMARY OF THE INVENTION

The present invention provides an improved collapsible plant stand that addresses at least the stated safety, assembly, and storage concerns surrounding prior devices.

In one embodiment, a collapsible plant support is provided that includes at least three side panels, having a flexible material coupled to a frame member which has a folded and an unfolded configuration. In a preferred embodiment, the material is indirectly coupled to the frame member by use of a pocket. The flexible material assumes the configuration of its associated frame member in its unfolded configuration. Each side panel has generally opposing top and bottom portions. Each side panel is coupled to at least two others, thereby generally forming a ring when the support is fully deployed. At least one of the side panels includes a plurality of apertures formed through its flexible material. The apertures formed in the flexible panel material may be unobstructed holes, which may be circular, or the apertures may be arcuate or curvilinear slits. If the apertures are holes, a flap may be secured to the panel material that enables selective closure of the holes. In a preferred embodiment, the flexible panel material is a string reinforced polyethylene sheet material.

Additional support structures may be provided, such as stake loops coupled to the lower portion of the panels and reinforcement gussets coupled to adjacent panels. The gussets may have a further hole formed therein to accept additional support mechanisms such as stakes or tie-down ropes.

In addition to the side panels, an embodiment of a plant support according to the present invention may incorporate a top panel coupled to the top portions multiple side panels. This top panel may include a top aperture. To enable selective closure of the top panel aperture, a top flap may be provided as hingedly coupled to the top panel, itself, or to the top portion of one of the side panels.

A flexible bottom panel may also be provided. A preferred bottom panel is formed of a fluid pervious material and includes an aperture, in the form of a slit, to enable plant growth therethrough.

In an alternative embodiment, a plant support according to the present invention may include at least three side panels and a plurality of flexible shelves. Each side panel includes a flexible pocket coupled to a frame member having a folded and an unfolded configuration. Each side panel is coupled to at least two others, thereby generally forming a ring when the support is fully deployed. The flexible shelves, which are preferably formed from a fluid pervious material, are selectively coupled to a plurality of said side panels. Each shelf may further include an aperture.

To maintain selective engagement between the plurality of shelves and the frame structure, a plant stand according to the present invention may further include a plurality of toggle clasps. Each toggle clasp has a toggle and a cooperating loop. The toggle may be operatively attached to a shelf and the loop may be operatively attached to at least one of the pockets, or vice versa. Alternatively, rather than being completely removable from all side panels, one or more of the shelves may be relatively permanently fastened to a side panel, such as being sewn thereto.

A still further embodiment of a collapsible plant stand according to the present invention may combine previous embodiments. In other words, a further embodiment may include at least three side panels that have a flexible material coupled to a flexible pocket, the flexible material assuming the configuration of its associated side panel frame member in its unfolded configuration. At least one of said side panels may include a plurality of apertures formed through said flexible material. Added to this structure may be a plurality of flexible shelves as previously described.

### BRIEF DESCRIPTION OF THE DRAWINGS

FIG. 1 is a perspective view of a first embodiment of a collapsible plant stand according to the present invention.

FIG. 2 is a perspective view of a second embodiment of a collapsible plant stand according to the present invention.

FIG. 3 is a partial cut-away perspective view of a bottom corner of the embodiment in FIG. 1.

FIG. 4 is a partial cut-away perspective view of a third embodiment of a collapsible plant stand according to the present invention.

FIG. 5 is a perspective view of a fourth embodiment of a collapsible plant stand according to the present invention.

FIG. 6 is a perspective view of a fifth embodiment of a collapsible plant stand according to the present invention.

FIG. 7 is a perspective view of an embodiment of a collapsible plant stand according to the present invention in a first folded configuration.

FIG. 8 is a perspective view of the embodiment of FIG. 7 in a second folded configuration.

FIG. 9 is a perspective view of the embodiment in FIG. 8 being collapsed.

FIG. 10 is a perspective view of the embodiment of FIG. 7 in a third folded configuration.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

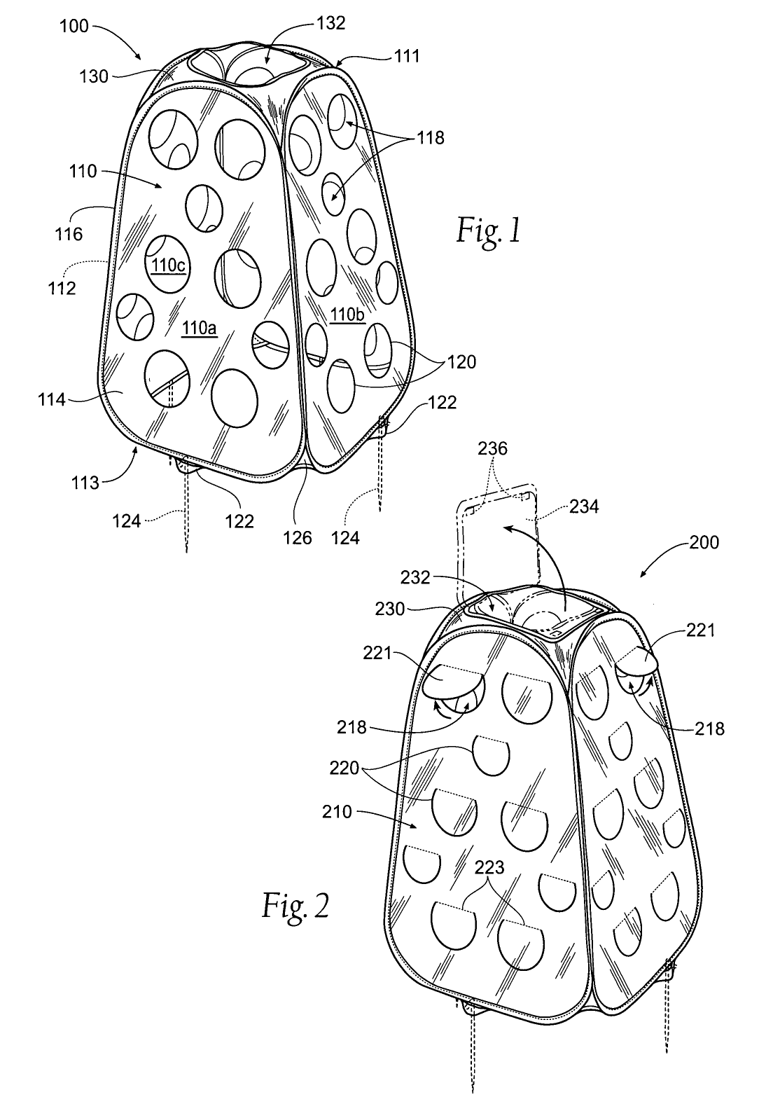

Turning now to the figures, FIG. 1 provides a first embodiment 100 of a collapsible plant stand according to the present invention. Generally, the embodiment 100 comprises at least three, but preferably four, collapsible side panels 110. Each side panel 110 includes a flexible frame member 112, which has a folded and unfolded configuration, and a flexible material 114 coupled, directly or indirectly, to the frame member 112. Each side panel 110 in its unfolded configuration has a top portion 111 and a bottom portion 113. The flexible material 114 may be directly coupled to the frame member 112 by cutting the material 114 in a desired shape slightly larger than the frame member 112 and by folding the material 114 around the frame member 112 and securing it thereto, either by fastening the material 114 to itself by way of adhesive, sewing or the like, or by fastening the material 114 to the frame member 112 by way of adhesive, for example. The flexible material 114 may be indirectly coupled to the frame member 112 by way of other structures, such as a support pocket 116 formed from a pocket material, which may or may not be the same composition as the panel flexible material 114.

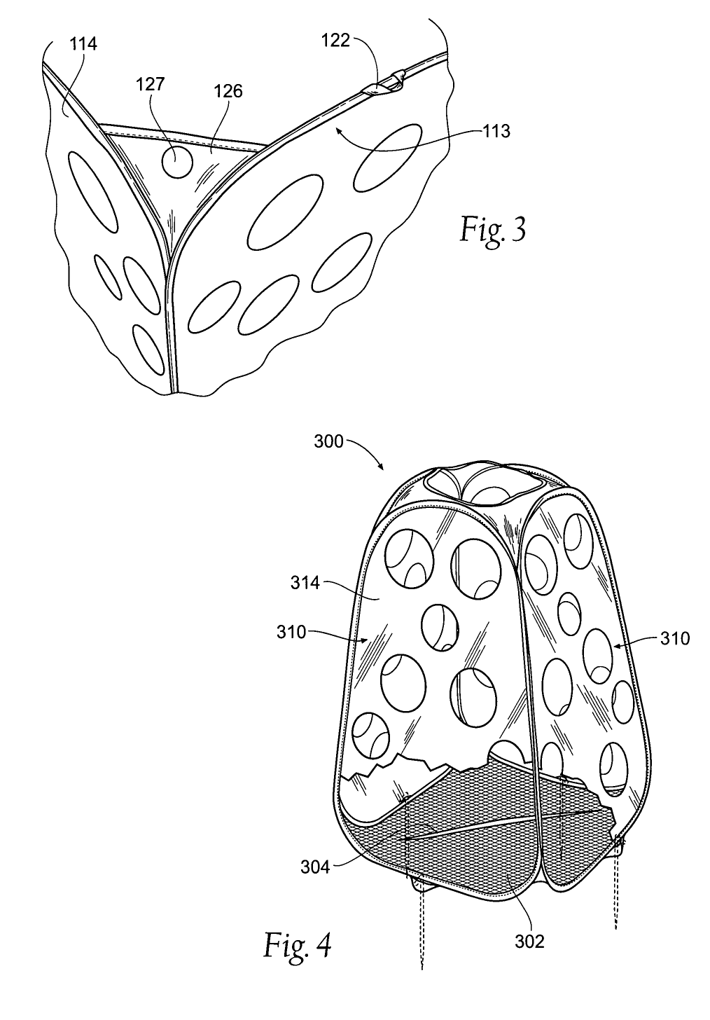

Other components may be provided as a part of, or fastened to, one or more of the side panels 110. For instance, stake loops 122 may be provided proximate the bottom portion 113 of one or more panels 110. Through the stake loops 122, a stake 124 may be inserted, thereby cooperating with the ground or other support surface to maintain the plant stand 100 in a desired location. In addition to the stake loops 122, reinforcement gussets 126 may be added as a part of or fastened to a plurality of side panels 110. These gussets 126, while aiding in maintaining structural integrity, may also provide an alternate or additional stake aperture 127 (see FIG. 3). In addition to stake loops 122 and support gussets 126, a top panel 130 may be provided, coupled to at least one but preferably multiple side panels 110 proximate the top portion 111 thereof. The top panel 130 is formed from a top panel material that may be the same as or different than the side panel material 114. Preferably provided in the top panel 130 is a top panel aperture 132, which may act as a vent or a watering access.

While the flexible material 114 may be any material suitable for supporting a given type of plant, the material preferably comprises a reinforced flexible plastic material such as a string reinforced polyethylene sheet material. The side panels 110 are generally arranged in a ring configuration so that a given panel 110a is coupled, directly or indirectly, to two other panels 110b,110c. At least one, but preferably all, of the side panels 110 include a plurality of apertures 118 formed through the flexible material 114. While the shape of the apertures 118 may be a matter of design choice, the apertures 118 are preferably circular openings 120 of suitable size, preferably about two to three inches in diameter.

To use this first embodiment 100 of a collapsible plant stand according to the present invention, the stand 100 is simply placed, in its uncollapsed configuration, over a young plant, such as a tomato plant, and preferably staked to the ground or tied to an existing support structure. As the plant matures, branches extending from the main stem of the plant may protrude through the apertures 118 in the side panels 110 and be supported thereby. The top aperture 132 allows sunlight and water to reach the plant generally free from obstruction.

A second embodiment 200 according to the present invention is shown in FIG. 2. This embodiment 200 may be useful as providing a selective greenhouse environment for a growing plant (not shown). The greenhouse effect may be provided by allowing substantial closure of the various apertures described in connection with the first embodiment 100. One closure may be provided in the form of a top flap 234 to cover a top aperture 232 formed in a top panel 230 of this embodiment 200. The top flap 234 may be hingedly coupled to the top panel 230 or a side panel 210 and releasably fastenable to the top panel 230 or a side panel 210 by way of, for example, a hook and loop type fastener 236. Additional closures may be provided to substantially cover some or all of the apertures 218 formed in the side panel material 214. Simply, rather than forming a complete circular opening 120 as shown in the prior embodiment 100, the apertures 218 may be formed by an arcuate slit 220, thereby cutting less than the entire circular opening from the material 214. That is, a flap 221 may be formed, which remains connected to the panel 210 at a hinge location 223. Alternatively, apertures may be formed in the side panel material similar to those in the first embodiment 100, and an additional flap of material (not shown) may be coupled to the side panel material to cover one or more of the apertures.

To use this second embodiment 200 of a collapsible plant stand according to the present invention, the stand 200 is, like the first embodiment, simply placed over a plant to be supported and preferably staked to the ground or fastened to another support structure. When a greenhouse effect is desired, the top flap 234 may be positioned over the top aperture 232, thereby closing off a primary heat vent. As the plant grows, branches may protrude through any aperture 218 formed in the side panels 210 and may then be supported thereby. If the stand 200 is placed over a more mature plant, existing branches may be manually fed through the apertures 218.

A third embodiment 300 according to the present invention is shown in FIG. 4 as having a bottom panel 302. The bottom panel 302 may serve as a weed shield and is operatively coupled, directly or indirectly, to a plurality of side panels 310. The bottom panel 302 is preferably provided with an aperture 304 in the form of a slit, to provide adequate clearance allowing growth of a desired plant (not shown). The bottom panel 302 may be formed from the same material as the side panel material 314, but the bottom panel 302 is preferably a partially opaque fluid pervious material. While allowing water to penetrate the panel 302, such a material would shade potential weeds from sunlight, thereby hampering their growth.

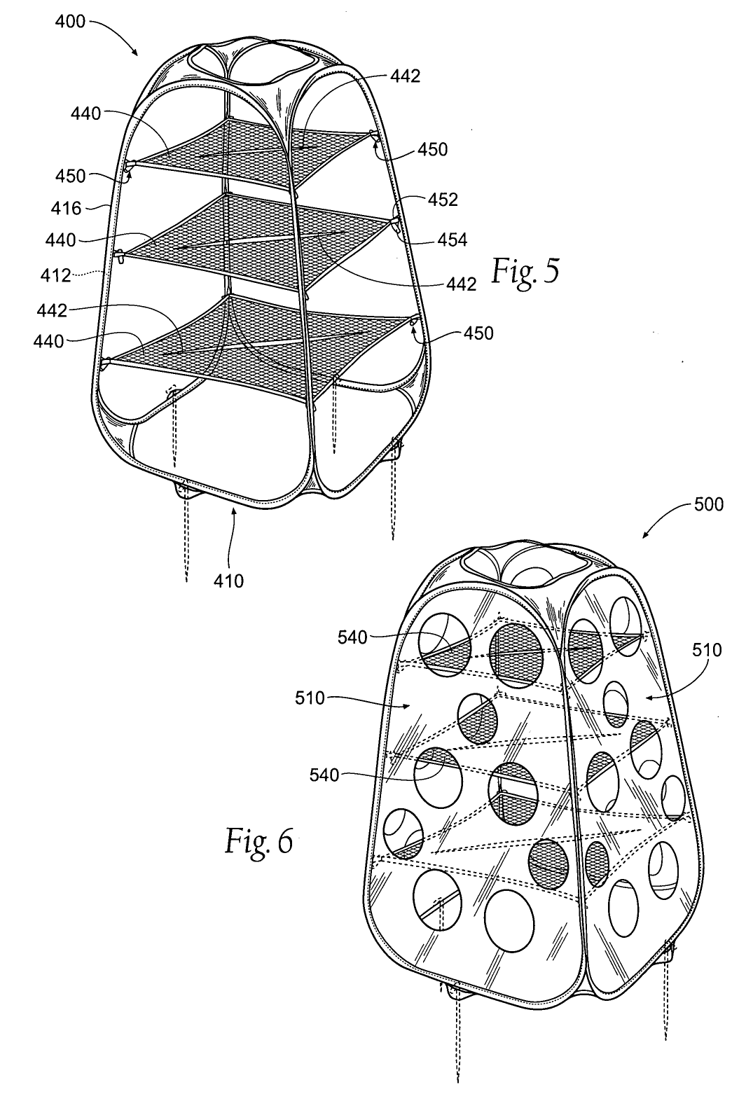

A fourth embodiment 400 according to the present invention is shown in FIG. 5. This plant stand 400 includes fruit shelves 440 suspended from a plurality of flexible frame members 412, which are preferably contained in frame pockets 416. The fruit shelves 440 may assist in supporting a growing plant and fruit suspended from the plant branches. The frame members 412 are generally arranged in a ring formation and indirectly coupled by way of the pockets 416 or other methods already known. An aperture 442, preferably in the form of a slit, is provided through each shelf 440 to allow a plant to grow therethrough. Each shelf 440 is preferably formed from a fluid pervious material and generally has a perimeter shaped to conform to the shape of a ring formed by unfolded and joined frames 412. Each shelf 440 is preferably completely uncoupleable from all frames 412 to allow selective placement thereof. A preferred shelf attachment structure allowing selective coupling with the frames 412 is a toggle clasp 450 including a loop 452 and a toggle 454. Alternatively, one or more of the shelves 440 may be relatively permanently attached to one of the side panels 410 by way of, for example, being sewn thereto.

To use the fourth embodiment 400, the stand is arranged as previously described with reference to other embodiments 100 and 200. Additionally, as the plant about which the stand has been placed begins to grow, its shoot will proceed through the apertures 442 provided in the fruit shelves 440, thereby allowing the shelves 440 to assist in supporting the plant and fruit depending from any branches thereof.

A fifth embodiment 500 according to the present invention is shown in FIG. 6. Like the fourth embodiment 400, this embodiment 500 includes fruit shelves 540, which are adapted to support fruit suspended from a plant between a central plant stem (not shown) and a plurality of side panels 510. The shelves 540 are of similar construction and operation to the shelves 440 of the fourth embodiment 400, and the side panels 510 of this embodiment 500 may be constructed similar to those panels 110 of the first embodiment 100; therefore, no further elaboration is provided.

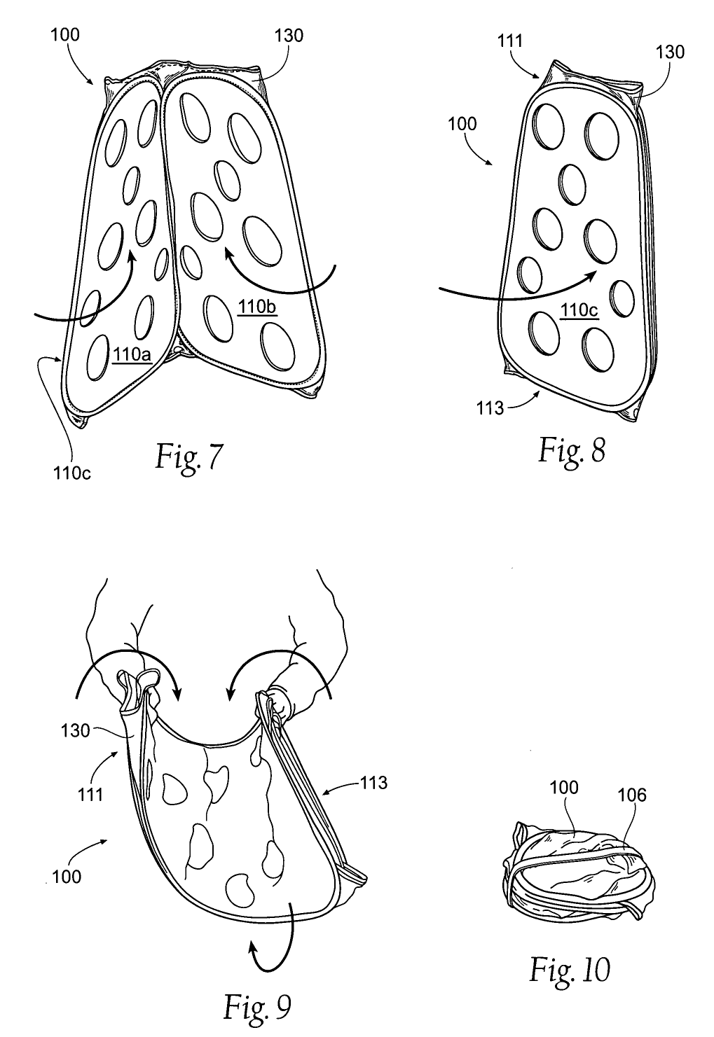

FIG. 7 provides a depiction of a first folded configuration of the embodiment of FIG. 1. In FIG. 7, a corner formed by two adjacent side panels 110a,110b has been forced towards the opposing corner formed by the other two adjacent side panels 110c,110d. In the event that an embodiment is formed with an odd number of side panels 110, one intersection of two side panels may be selectively disengageable, thereby allowing a zig-zag fold of the panels. In a second folded configuration, shown in FIG. 8, the two adjacent side panels 110a,110b have been folded to lie against each other, thereby forming a generally flat collapsed plant stand 100 which may be stored accordingly, if desired. If further collapsibility is warranted, the plant stand 100 may be folded into a third folded configuration.

FIG. 9 and FIG. 10 illustrate a further collapse of the embodiment of FIG. 1 into a third folded configuration. Along a side of the flat stand shown in FIG. 8, a user may place thumbs on one panel 110c and fingers opposed on another panel 110d. A simple rotation of each wrist toward the other causes the stand 100 to coil into thirds. An elastic strap 106 may be provided to maintain the third folded configuration for storage.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A collapsible plant support comprising:
at least three side panels, each side panel comprising a flexible material coupled to a frame member having a folded and an unfolded configuration, the flexible material assuming the configuration of its associated frame member in its unfolded configuration, each side panel having opposing top and bottom portions;
wherein each side panel is coupled to at least a first adjacent side panel and a second adjacent side panel; and
wherein at least one of said side panels comprises a plurality of apertures formed through said flexible material.

2. A collapsible plant support according to claim 1, wherein each said panel flexible material is directly coupled to a frame member.

3. A collapsible plant support according to claim 1, further comprising a stake loop coupled to said bottom portion of at least one of said side panels.

4. A collapsible plant support according to claim 1, further comprising a reinforcement gusset coupled to said bottom portion of two adjacent side panels.

5. A collapsible plant support according to claim 4, said reinforcement gusset including an aperture therethrough.

6. A collapsible plant support according to claim 1, wherein at least one of said plurality of apertures is an unobstructed opening.

7. A collapsible plant support according to claim 6, further comprising a flap hingedly coupled to said flexible material, said flap substantially covering said unobstructed opening.

8. A collapsible plant support according to claim 6, wherein said opening is circular.

9. A collapsible plant support according to claim 1, wherein at least one of said plurality of apertures comprises a slit.

10. A collapsible plant support according to claim 9, wherein said slit is curvilinear.

11. A collapsible plant support according to claim 1, further comprising a flexible top panel coupled to said top portion of a plurality of said side panels.

12. A collapsible plant support according to claim 11, said flexible top panel including a top aperture.

13. A collapsible plant support according to claim 12, further comprising a top flap hingedly coupled to said top panel.

14. A collapsible plant support according to claim 12, further comprising a top flap hingedly coupled to said top portion of one of said side panels.

15. A collapsible plant support according to claim 1, said flexible material comprising string reinforced polyethylene sheet material.

16. A collapsible plant support according to claim 1, further comprising a flexible bottom panel.

17. A collapsible plant support according to claim 16, said bottom panel comprising a fluid pervious material.

18. A collapsible plant support according to claim 16, said flexible bottom panel including a bottom aperture.

19. A collapsible plant support according to claim 18, said bottom aperture comprising a slit.

20. A collapsible plant support comprising:
at least three side panels, each side panel comprising a flexible pocket coupled to a frame member having a folded and an unfolded configuration;
each side panel being coupled to at least a first adjacent side panel and a second adjacent side panel; and
a plurality of flexible shelves, said shelves being selectively coupled to a plurality of said side panels.

21. A collapsible plant support according to claim 20, said flexible shelves comprising a fluid pervious material.

22. A collapsible plant support according to claim 20, each of said flexible shelves further comprising an aperture formed therethrough.

23. A collapsible plant support according to claim 20, further comprising a plurality of toggle clasps, each toggle clasp comprising a toggle and a cooperating loop, wherein said toggle is operatively attached to a shelf and said loop is operatively attached to at least one of said pockets.

24. A collapsible plant support according to claim 20, wherein one of said shelves is sewn to one of said side panels.

25. A collapsible plant support according to claim 20, each side panel further comprising a flexible material coupled to said flexible pocket, the flexible material assuming the configuration of its associated side panel frame member in its unfolded configuration;
wherein at least one of said side panels comprises a plurality of apertures formed through said flexible material.
